(19) United States
(12) Patent Application Publication
(10) Pub. No.: US 2020/0166626 A1
(43) Pub. Date: May 28, 2020

(54) INFORMATION PROCESSING DEVICE, INFORMATION PROCESSING METHOD, AND STORAGE MEDIUM HAVING PROGRAM STORED THEREON

(71) Applicant: NEC Corporation, Minato-ku, Tokyo (JP)

(72) Inventors: Hisatoshi TORIYA, Tokyo (JP); Taichi TANAKA, Tokyo (JP)

(73) Assignee: NEC Corporation, Minato-ku, Tokyo (JP)

(21) Appl. No.: 16/613,180

(22) PCT Filed: May 17, 2017
(86) PCT No.: PCT/JP2017/018524

§ 371 Date: Nov. 13, 2019

(51) Int. Cl. G01S 13/42; G01S 13/04; G01S 13/60; G01S 13/90

(52) U.S. Cl. CPC G01S 13/426; G01S 13/9004; G01S 13/605; G01S 13/04

(57) ABSTRACT

This information processing device is provided with: a candidate point extraction unit for extracting, on the basis of the position in three-dimensional space of a target point specified in an intensity map of a signal from an observed object acquired through radar and the shape of the observed object, a candidate point that contributes to the signal at the target point; an evaluation unit for evaluating the reliability of the candidate point in terms of signal analysis on the basis of geographic information indicating the state of a surface including the candidate point; and an output unit for outputting information indicating the result of the evaluation.

### TECHNICAL FIELD

The present disclosure relates to processing of data acquired by a radar.

### BACKGROUND ART

A technique of observing and analyzing a district which is wished to be observed from the sky has been spread for the purpose of observing a state of the earth's surface or the like.

A synthetic aperture radar (SAR) is one of techniques of observing a state of the earth's surface by radiating an electromagnetic wave from the sky and acquiring an intensity of the electromagnetic wave reflected by backward scattering (hereinafter, the reflected electromagnetic wave is also referred to as a “reflected wave”).

NPL 1 describes a technique called a permanent scatterer interferometric SAR (PS-InSAR), which is a technique of analyzing for a permanent scatter (PS) at data acquired by a SAR. The permanent scatterer is a point at which a scattering characteristic with respect to an electromagnetic wave is changeless (also called stable), in other words, is less likely to change with time. In the PS-InSAR, it is possible to observe a change in terrain or the like by observing a displacement of the permanent scatterer in SAR data acquired by a plurality of measurements.

Data on a reflected wave acquired by a SAR are, for example, indicated by a two-dimensional map (hereinafter, a “SAR image”) on an intensity of the reflected wave. The SAR image is a map in which the intensity of the reflected wave is indicated on a plane representing a reference plane by regarding the reflected wave as a reflected wave from the defined reference plane (e.g. a ground).

A position at which the intensity of the reflected wave is indicated in the SAR image is based on a distance between a position at which the reflected wave is generated, and a position of an antenna for receiving the reflected wave. Therefore, the intensity of the reflected wave from a position away from the reference plane (specifically, a position where the altitude is not zero) is indicated, in the SAR image, at a position displaced from the actual position to the radar side depending on a height from the reference plane. Consequently, an image, in the SAR image, to be formed by the reflected wave from an object with a shape that is not flat, becomes an image in which the shape of the actual object is distorted. A phenomenon in which the distorted image as described above is generated is called foreshortening.

In order to correct the foreshortening, a device for performing correction processing called ortho-correction is disclosed in PTLs 1 and 2.

PTL 3 discloses a technique of performing correction with respect to not only the foreshortening but also a phenomenon called layover. The layover is a phenomenon in which a signal of the reflected wave from a certain height position, and a signal of the reflected wave from a position other than the certain position overlap each other in the SAR image.

### CITATION LIST

### Patent Literature

[PTL 1] Japanese Unexamined Patent Application Publication No. 2007-248216
[PTL 2] Japanese Unexamined Patent Application Publication No. 2008-90808
[PTL 3] Japanese Unexamined Patent Application Publication No. 2008-185375

### Non Patent Literature

[NPL 1] Ferretti, Alessandro, Claudio Prati, and Fabio Rocca, “Permanent scatterers in SAR interferometry”, IEEE transactions on geoscience and remote sensing, Vol. 39, No. 1, January 2001, p. 8-20.

### SUMMARY OF INVENTION

### Technical Problem

In the ortho-correction as disclosed in PTLs 1 and 2, performing correction, with respect to the SAR image in which the layover occurs, is not assumed. Specifically, the ortho-correction is a correction in which a position of a point at which distortion occurs in the SAR image is shifted to a position, which is estimated to be a true position at which a signal (reflected wave) indicated at the point is emitted. In other words, the ortho-correction is a correction performed based on a premise that the number of candidates of a position, which is estimated to be a true position at which the reflected wave is emitted at a point serving as a correction target, is one.

In the ortho-correction as disclosed in PTLs 1 and 2, it is not possible to perform correction with respect to a point within a region where the layover occurs. This is because, when the layover occurs, there may be a plurality of candidates for a position, which is estimated to be a true position at which a signal indicated at a point being present within a region where the layover occurs is emitted.

PTL 3 discloses a method of correcting the layover. In the method, however, a plurality of the SAR images in which distortion patterns are different are necessary. In this way, unless some additional information is available, fundamentally, it is not possible to distinguish the reflected waves from two or more places, within one SAR image, which contribute to a signal at a point within the region where the layover occurs.

When the layover is not corrected, specifically, when a candidate of a place which contributes to a signal at a certain point in the SAR image is not narrowed, usually, a person estimates the candidate of the place which contributes to the signal based on experiences and various pieces of information, while watching the SAR image and an optical image.

However, it is difficult to comprehend the SAR image, and estimate the candidate of the place which contributes to a signal indicated by a point in the SAR image. Further, when the plurality of candidates are found, it is also important in analyzing an observation result to determine whether each of the candidates truly contributes to the signal, or how far the candidates contribute to the signal, and the like.

One of objects of the present invention is to provide a device, a method, and the like for providing useful information relating to a place which contributes to a signal at a point within a region where the layover occurs in the SAR image. It is noted that, an image to be used in the present invention may be, in addition to the SAR image, an image to be acquired by another method of estimating a state of a target object by observing reflection of the electromagnetic wave, such as an image based on a real aperture radar (RAR).

### Solution to Problem

An information processing device according to an example aspect of the present disclosure, includes: candidate point extraction means for extracting a candidate point based on a position of a target point in a three-dimensional space and a shape of an observed object, the target point being a point to be specified in an intensity map of a signal acquired from the observed object by a radar, the candidate point being a point which contributes to the signal at the target point; evaluation means for performing evaluation on reliability regarding analysis with respect to the signal emitted at the candidate point based on geographic information about a state of the earth's surface including the candidate point; and output means for outputting information about a result of the evaluation.

An information processing method according to an example aspect of the present disclosure, includes: extracting a candidate point based on a position of a target point in a three-dimensional space and a shape of an observed object, the target point being a point to be specified in an intensity map of a signal acquired from the observed object by a radar, the candidate point being a point which contributes to the signal at the target point; performing evaluation on reliability regarding analysis with respect to the signal emitted at the candidate point based on geographic information about a state of the earth's surface including the candidate point; and outputting information about a result of the evaluation.

A computer readable storage medium according to an example aspect of the present disclosure stores a program causing a computer to execute: extracting a candidate point based on a position of a target point in a three-dimensional space and a shape of an observed object, the target point being a point to be specified in an intensity map of a signal acquired from the observed object by a radar, the candidate point being a point which contributes to the signal at the target point; performing evaluation on reliability regarding analysis with respect to the signal emitted at the candidate point, based on geographic information about a state of the earth's surface including the candidate point; and outputting information about a result of the evaluation.

### Advantageous Effects of Invention

The present invention provides useful information relating to a place which contributes to a signal at a point within a region where the layover occurs in an intensity map of a signal from an observed object acquired by the radar.

### BRIEF DESCRIPTION OF DRAWINGS

FIG. 1 is a diagram illustrating a positional relationship between a satellite for performing observation by SAR, and a target object.

FIG. 2 is an example of the SAR image.

FIG. 3 is a block diagram illustrating a configuration of an information processing device according to a first example embodiment of the present invention.

FIG. 4 is a diagram illustrating an example of candidate points.

FIG. 5 is a diagram illustrating one example of a method of extracting the candidate point.

FIG. 6 is a diagram illustrating an example of data indicating evaluation values given to the candidate points.

FIG. 7 is a diagram illustrating an example of data indicating a relationship between an evaluation value and a display pattern.

FIG. 8 is a flowchart illustrating a flow of processing by the information processing device according to the first example embodiment.

FIG. 9 is an example of a point display image.

FIG. 10 is another example of the point display image.

FIG. 11 is a block diagram illustrating a configuration of an information processing device according to a modification example of the first example embodiment.

FIG. 12 is an example of the point display image generated by the information processing device according to the modification example of the first example embodiment.

FIG. 13 is another example of the point display image generated by the information processing device according to the modification example of the first example embodiment.

FIG. 14 is a block diagram illustrating a configuration of an information processing device according to a second example embodiment of the present invention.

FIG. 15 is a block diagram illustrating a configuration of an information processing device according to one example embodiment of the present invention.

FIG. 16 is a flowchart illustrating a flow of an operation of the information processing device according to one example embodiment of the present invention.

FIG. 17 is a block diagram illustrating an example of a hardware constituting each unit in each of the example embodiments according to the present invention.

### EXAMPLE EMBODIMENT

Before example embodiments according to the present invention are described, a principle as to how the layover occurs in observation by the SAR is described.

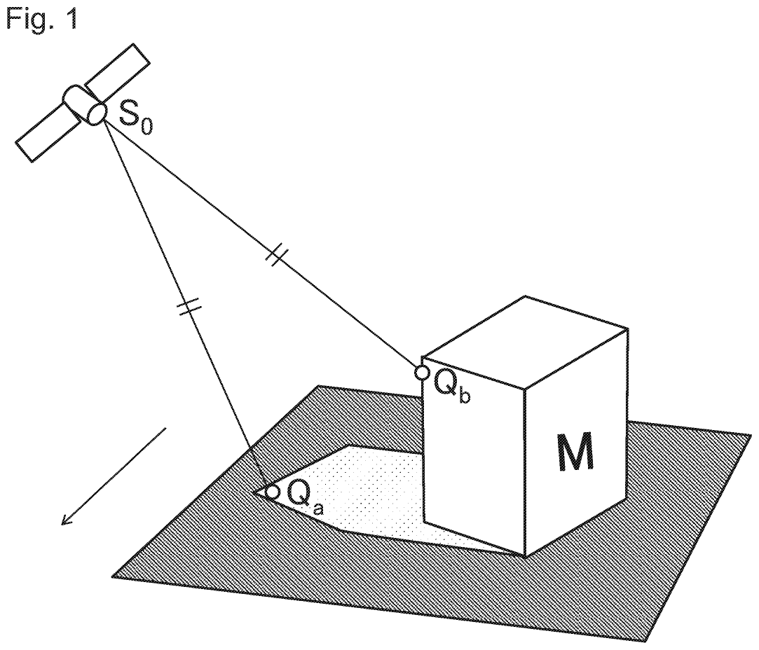

FIG. 1 is a diagram for describing the layover. FIG. 1 illustrates observation equipment S₀ for performing observation by the SAR, and an object M present within an area to be observed. The observation equipment S₀ is, for example, an artificial satellite, an aircraft, or the like in which a radar is mounted. The observation equipment S₀ emits an electromagnetic wave from the radar, and receives the reflected electromagnetic wave, while hovering in the sky. In FIG. 1, the arrow indicates a traveling direction of the observation equipment S₀, specifically, the traveling direction of the radar (also referred to as an azimuth direction). The electromagnetic wave emitted from the observation equipment S₀ is reflected, by backward scattering, on the ground and the structure M that present on the ground. Then, a part of the reflected wave returns to the radar and is received. Thus, a distance between a position of the observation equipment S₀, and a reflected point of the electromagnetic wave at the structure M is specified.

In FIG. 1, a point Qₐ is a point on the ground, and a point Q_{b} is a point, on a surface of the structure M, away from the ground. It is assumed that a distance between the observation equipment S₀ and the point Qₐ is equal to a distance between the observation equipment S₀ and the point Q_{b}. Further, a straight line connecting the point Q_{b} and the point Qₐ, and the traveling direction of the radar has a vertical relationship. In a case as described above, it is not possible to distinguish, by the observation equipment S₀, the reflected wave at the point Qₐ from a reflected wave at the point Q_{b}. Specifically, an intensity of the reflected wave from the point Qₐ and an intensity of the reflected wave from the point Q_{b} are observed in an indistinguishable state.

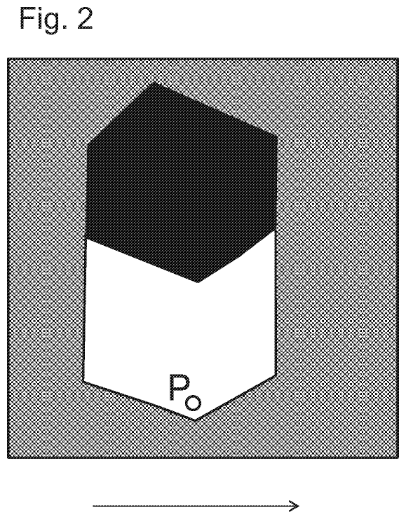

FIG. 2 illustrates an example of an image (hereinafter, referred to as a “SAR image”) indicating an intensity distribution of the reflected wave generated in a case as described above. In FIG. 2, the arrow indicates the traveling direction of the radar. The SAR image is generated based on the intensity of the reflected wave received by the radar, and a distance between a place at which the reflected wave is emitted and the radar. In the SAR, reflected waves from two or more places where distances from the radar are equal, on a flat plane including a position of the radar and perpendicular to the traveling direction of the radar, are not distinguished one from another. Although a point P is a point which reflects the intensity of the reflected wave from the point Qₐ, the intensity indicated at the point P also reflects the intensity of the reflected wave from the point Q_{b}. In this way, a phenomenon such that intensities of reflected waves from two or more places overlap one another at one point in the SAR image is the layover. In FIG. 2, a white area including the point P is an area where the layover occurs. Note that, a black area in FIG. 2 indicates an area, which becomes a shadow to the radar by the structure M. The area is also referred to as a radar shadow.

In the following, example embodiments of the present invention are described in detail with reference to the drawings.

### First Example Embodiment

First, a first example embodiment of the present invention is described.

<Configuration>

In the following description, it is assumed that a three-dimensional space as a reference is defined in processing to be performed by an information processing device 11. A three-dimensional coordinate system is defined with respect to the three-dimensional space as a reference. In the following, the three-dimensional coordinate system is described as a reference three-dimensional coordinate system or a reference coordinate system. The reference coordinate system may be, for example, a geodetic system, or a coordinate system of model data 1113 being three-dimensional data to be described later.

Further, in the following, description such that a point to be described in a first coordinate system is describable in a second coordinate system is described such that the first coordinate system is associated with the second coordinate system.

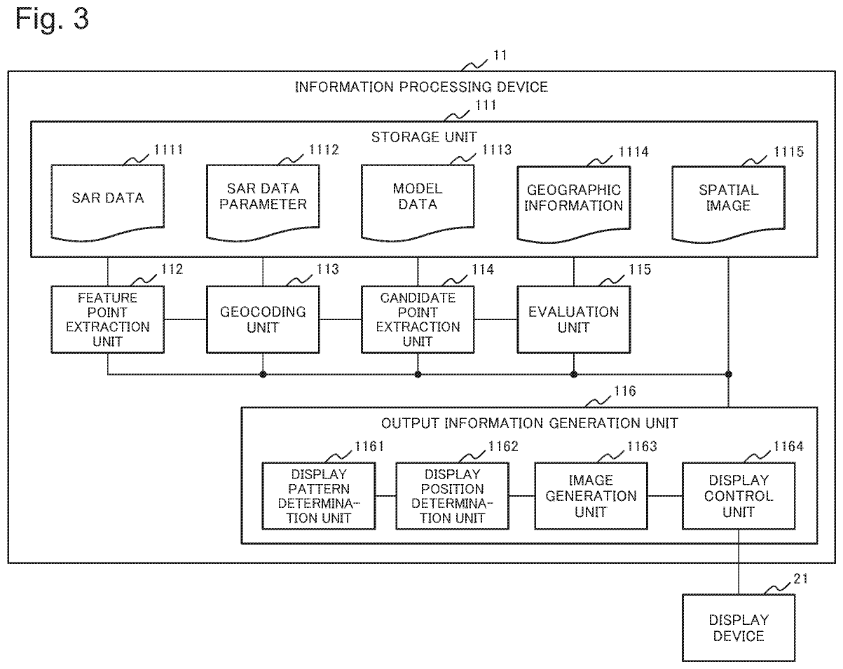

FIG. 3 is a block diagram illustrating a configuration of the information processing device 11 according to the first example embodiment. The information processing device 11 includes a storage unit 111, a feature point extraction unit 112, a geocoding unit 113, a candidate point extraction unit 114, an evaluation unit 115, and an output information generation unit 116. The storage unit 111, the feature point extraction unit 112, the geocoding unit 113, the candidate point extraction unit 114, the evaluation unit 115, and the output information generation unit 116 are connected in such a way that mutual data communication is enabled. Note that, data communication between units included in the information processing device 11 may be directly performed via a signal line, or may be performed by reading and writing to and from a shared storage area (e.g. the storage unit 111). In the following description, data communication is described by wording “data are transmitted” and “data are received”. However, a method of communicating data is not limited to a method of directly communicating data.

The information processing device 11 is communicably connected to a display device 21.

===Storage unit 111===

The storage unit 111 stores data necessary for processing by the information processing device 11. For example, the storage unit 111 stores SAR data 1111, a SAR data parameter 1112, the model data 1113, geographic information 1114, and a spatial image 1115.

The SAR data 1111 are data acquired by observation using the SAR. A target to be observed by the SAR (hereinafter, the target is also described as an “observed object”) is, for example, a ground, a building, and the like. The SAR data 1111 are at least data capable of generating the SAR image indicated in a coordinate system associated with the reference coordinate system.

For example, the SAR data 1111 include an observation value, and information associated with the observation value. The observation value is, for example, an intensity of an observed reflected wave. The information associated with the observation value includes, for example, information such as a position and the traveling direction of the radar which observes the reflected wave at a time when the reflected wave is observed; and a distance between a reflected point to be derived by observation of the reflected wave and the radar. The SAR data 1111 may include information on an angle of depression of the radar with respect to the observed object (an angle of elevation of the radar viewed from the reflected point). The information relating to the position is described, for example, by a set of a longitude, a latitude, and an altitude in the geodetic system.

The SAR data 1111 may be the SAR image itself.

Note that, in description of the present example embodiment, observation data by the SAR are assumed as data to be used. In another example embodiment, not data by the SAR, but data on an observation result by the real aperture radar (RAR) may be used, for example.

Note that, the electromagnetic wave to be used in measurement by the radar is an electromagnetic wave (e.g., a radio wave of 100 μm or more) of a wavelength longer than a wavelength of visible light.

The SAR data parameter 1112 is a parameter indicating a relationship between data included in the SAR data 1111, and the reference coordinate system. In other words, the SAR data parameter 1112 is a parameter for giving a position in the reference coordinate system to an observation value included in the SAR data 1111.

For example, when, in the SAR data 1111, information described in the geodetic system, and relating to a position and the direction of the radar, and a distance between the radar and the observed object is associated with the observation value, the SAR data parameter 1112 is a parameter for converting the information into information to be described in the reference coordinate system.

When the SAR data 1111 is the SAR image, a coordinate system of the SAR image is associated with the reference coordinate system by the SAR data parameter 1112. Specifically, any point in the SAR image is associated with one point in the reference coordinate system.

The model data 1113 is data indicating a shape of an object such as terrain or a structure of a building in terms of three dimensions. The model data 1113 is, for example, a digital elevation model (DEM). The model data 1113 may be a digital surface model (DSM) being data on the earth's surface including a structure, or may be a digital terrain model (DTM) being data on a shape of a ground. The model data 1113 may individually include the DTM and three-dimensional data on a structure.

A coordinate system to be used in the model data 1113 is associated with the reference coordinate system. Specifically, any point within the model data 1113 is describable by a coordinate in the reference coordinate system.

The geographic information 1114 is information about a state of the earth's surface. More specifically, the geographic information 1114 is information in which a value of an index indicating a state of the earth's surface is associated with a point or an area on the earth's surface.

Note that, in the present disclosure, the “earth's surface” includes a surface of a structure on the ground.

The index indicating a state of the earth's surface is, for example, a normalized difference vegetation index (NDVI) being an index indicating a condition of vegetation.

The NDVI is described in detail in the following Document 1.

Document 1: BUHEAOSIER, Masami KANEKO, and Masayuki TAKADA, “THE CLASSIFICATION OF VEGETATION OF WETLAND BASED ON REMOTE SENSING METHODS, OVER KUSHIRO WETLAND HOKKAIDO JAPAN”, Report of Hokkaido Institute of Environmental Sciences, Hokkaido Institute of Environmental Sciences, 2002, Vol. 29, p. 53 to 58

A value of the NDVI is calculated by using reflectances of visible red light and near infrared light. For example, when it is assumed that an intensity of reflected near infrared light is NIR, and an intensity of reflected red light is VIS, the NDVI is calculated by an equation: NDVI=(NIR−VIS)/(NIR+VIS). The larger a value of the NDVI is, the denser vegetation is. This is because, as vegetation becomes denser, red light is absorbed well, and near infrared light is reflected strong.

Note that, as the vegetation becomes denser, the electromagnetic wave (radio wave) from the radar is less likely to cause backward scattering in the sky. This is because, as the vegetation becomes denser, the radio wave is likely to be absorbed. Specifically, there is a correlation between a value of the NDVI, and an intensity of a reflected signal of the radio wave.

The geographic information 1114 may be, for example, information in which a value of a normalized difference water index (NDWI) being an index of water on the earth's surface is associated with the earth's surface and recorded. Document 1 also describes a method of calculating the NDWI. The NDWI is also an index based on reflectances of visible red light and near infrared light. Note that, in an area where a large amount of water is contained, the electromagnetic wave from the radar is less likely to cause backward scattering in the direction of the radar. This is because the electromagnetic wave is likely to cause specular reflection in the area where the large amount of water is contained.

The geographic information 1114 may be a pixel value of each pixel in an optical image. When a correspondence between a point within an optical image and a point on the earth's surface is determined the pixel value of the point within the optical image is information about a state of the earth's surface at a point on the earth's surface associated with the point within the optical image. Note that, the pixel value is, for example, an RGB value. The pixel value may be a luminance value indicating brightness.

Note that, the optical image may be the spatial image 1115 to be described later. Specifically, the geographic information 1114 may be acquired from the spatial image 1115 to be described later.

The geographic information 1114 may be the SAR data. When a correspondence between a point in the SAR data and a point on the earth's surface is determined, a signal intensity of the point in the SAR data is information about a state of the earth's surface at the point on the earth's surface associated with the point in the SAR data.

The spatial image 1115 is an image in which a space including the observed object by the SAR is displayed. The spatial image 1115 may be, for example, any of an optical image such as a satellite photograph or an aerial photograph, a map, a topographic map, and an image of a computer graphics (CG) indicating terrain. The spatial image 1115 may be a projection map of the model data 1113. Preferably, the spatial image 1115 may be an image in which a physical configuration, a layout, and the like of an object within a space indicated by the spatial image 1115 is intuitively comprehensible to a user of the information processing device 11 (specifically, a person who browses an image to be output by the information processing device 11).

The spatial image 1115 may be extracted from an outside of the information processing device 11, or may be generated by projecting the model data 1113 by an image generation unit 1163 to be described later.

The spatial image 1115 may be associated with capturing condition information being information about capturing conditions of the spatial image 1115. The capturing conditions of the spatial image 1115 are a way of capturing the spatial image 1115. The capturing condition information is information capable of uniquely identifying a capturing area of the spatial image 1115. The capturing condition information is, for example, indicated by values of a plurality of parameters relating to a capturing area of the spatial image 1115.

Note that, in the present disclosure, the spatial image is regarded as a captured image captured from a specific position, and a member which performs capturing (e.g. a capturing device such as a camera) is referred to as a capturing body. When the spatial image 1115 is an image acquired without actually undergoing a capturing process by a device, such as a case where the spatial image 1115 is generated by projection of the model data 1113, the capturing body may be virtually set.

The capturing condition information is described, for example, by a position of the capturing body, and information about an area of the captured body. As an example, when the spatial image 1115 has a rectangular shape, the capturing condition information may be described by the coordinate in the reference coordinate system of the capturing body, and four coordinates in the reference coordinate system, which are equivalent to places projected at four corners of the spatial image 1115. Note that, in this case, the capturing area is an area surrounded by four half lines respectively extending toward the four coordinates from a position of the capturing body.

Note that, although the position of the capturing body is, strictly speaking, a position of a viewpoint of the capturing body with respect to the spatial image 1115, practically, information on the position of the capturing body does not have to be precise. As one example, information about the position of the capturing body may be information on a position acquired by a device having a global positioning system (GPS) function, which is mounted in an apparatus (such as an aircraft or an artificial satellite) in which the capturing body is mounted.

Note that, information about a position in the capturing condition information is, for example, given by a set of values of parameters (e.g., a longitude, a latitude, and an altitude) in the reference coordinate system. Specifically, a position, in the reference three-dimensional space, of any point included in a spatial area included in the spatial image 1115 can be uniquely identified by the capturing condition information. Conversely, when any point (at least a feature point and a candidate point to be described later) in the reference three-dimensional space is included in the spatial image 1115, a position of the point within the spatial image 1115 can be uniquely identified based on the capturing condition information.

Each of the parameters of the capturing condition information may be a parameter of a coordinate system other than the reference coordinate system. In this case, the capturing condition information may include a conversion parameter for converting a value of a parameter in the coordinate system into a value of the parameter in the reference coordinate system.

The capturing condition information may be described, for example, by a position, a posture, and a view of angle of the capturing body. The posture of the capturing body can be described by a capturing direction, specifically, an optical axis direction of the capturing body at a capturing time, and a parameter indicating a relationship between an up-down direction of the spatial image 1115 and the reference coordinate system. When the spatial image 1115 has, for example, a rectangular shape, the angle of view can be described by a parameter indicating an angle of visibility in the up-down direction and an angle of visibility in a left-right direction.

When the capturing body is sufficiently far from a subject, such as a case where the capturing body is a camera mounted in an artificial satellite, information about the position of the capturing body may be described by a value of a parameter indicating the direction of the capturing body viewed from the subject. For example, information about the position of the capturing body may be a set of an azimuth and an angle of elevation.

Note that, the storage unit 111 does not have to constantly store data inside the information processing device 11. For example, the storage unit 111 may record data in an external device of the information processing device 11, a recording medium, or the like, and acquire the data as necessary. Specifically, the storage unit 111 needs only to be configured in such a way that data requested by each unit can be acquired in processing of each unit of the information processing device 11 to be described in the following.

===Feature Point Extraction Unit 112===

The feature point extraction unit 112 extracts the feature point from the SAR data 1111. In the present disclosure, the feature point is, in the SAR data 1111, a point to be extracted by a predetermined method from a plurality of points indicating a signal intensity being at least not zero. Specifically, the feature point extraction unit 112 extracts one or more points from the SAR data 1111 by a predetermined method of extracting a point. Note that, in the present disclosure, a point to be extracted from the SAR data 1111 is a data group relating to one point in the SAR image (e.g., a set of an observation value, and information associated with the observation value).

The feature point extraction unit 112 extracts the feature point by a method of extracting a point, which may give useful information in analysis with respect to the SAR data 1111, for example.

For example, the feature point extraction unit 112 may extract, as the feature point, a permanent scatterer to be specified by the above-described PS-InSAR.

Alternatively, the feature point extraction unit 112 may extract, as the feature point, a point that satisfies a predetermined condition (e.g., a condition that a signal intensity exceeds a predetermined threshold value, or the like). The predetermined condition may be, for example, set by a user or a designer of the information processing device 11. The feature point extraction unit 112 may extract, as the feature point, a point selected by personal judgment.

The feature point extraction unit 112 transmits, to the geocoding unit 113, information on the extracted feature point. The information on the feature point includes at least information capable of specifying a coordinate in the reference coordinate system. As an example, the information on the feature point is indicated by the position and the traveling direction of observation equipment which acquires the SAR data within an area including the feature point, and a distance between the observation equipment and a reflected place of a signal at the feature point.

===Geocoding unit 113===

The geocoding unit 113 gives a coordinate in the reference coordinate system to each of feature points extracted by the feature point extraction unit 112. The geocoding unit 113, for example, receives information on the extracted feature point from the feature point extraction unit 112. The geocoding unit 113 specifies which one of signals from positions within the reference three-dimensional space is associated with a signal of the feature point based on the received feature point information, and the SAR data parameter 1112.

For example, when the feature point information is indicated by the position and the traveling direction of observation equipment which acquires the SAR data within an area including the feature point, and a distance between the observation equipment and the reflected place of the signal at the feature point, first, the geocoding unit 113 converts the information into information to be indicated by the position, the traveling direction, and the distance of the observation equipment in the reference coordinate system based on the SAR data parameter 1112. Further, the geocoding unit 113 specifies a point (coordinate) which satisfies all the following conditions in the reference coordinate system.
A distance between the point and the position of the observation equipment is the distance indicated by the feature point information.
The point is included in a flat plane perpendicular to the traveling direction of the observation equipment.
The point is included in a reference plane (a plane where the altitude is zero in the reference coordinate system).
   The coordinate of the specified point is a coordinate, in the reference coordinate system, of the feature point indicated by the feature point information. The geocoding unit 113 gives the coordinate of the point specified in this way, for example, to the feature point indicated by the feature point information.

===Candidate Point Extraction Unit 114===

The candidate point extraction unit 114 associates a point (hereinafter, a “candidate point”) associated with the feature point with the feature point to which the coordinate in the reference coordinate system is given. The candidate point associated with the feature point is described in the following.

A signal intensity indicated at the feature point (assumed to be a point P) within a region where the layover occurs may be a sum of intensities of reflected waves from a plurality of points. In this case, a point within a three-dimensional space, which may contribute to the signal intensity indicated at the point P, is referred to as the candidate point associated with the point P in the present example embodiment.

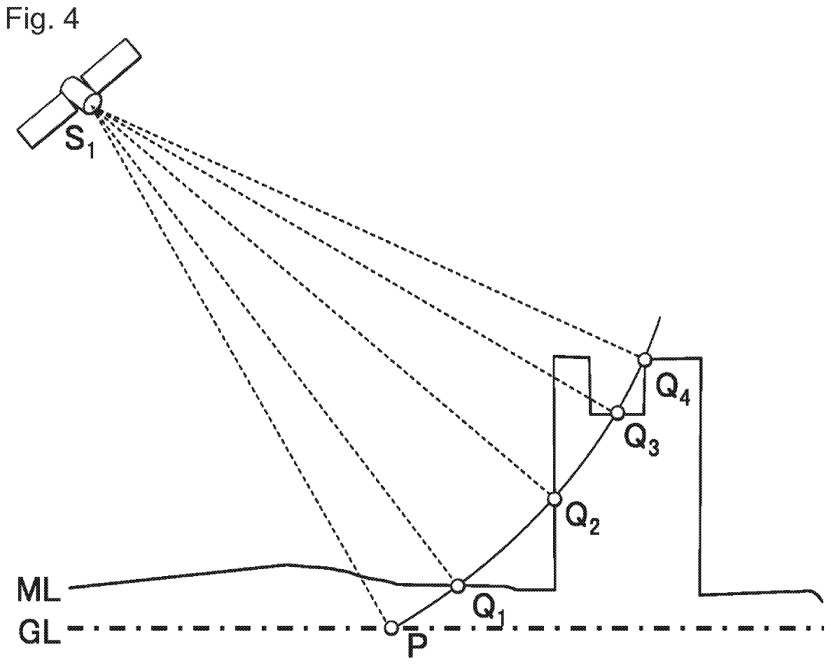

FIG. 4 is a diagram illustrating an example of the candidate point. FIG. 4 is a cross-sectional view in which the reference three-dimensional space is taken along a flat plane passing through the point P and perpendicular to the traveling direction (azimuth direction) of the radar.

A line GL is a cross-sectional line of a reference plane in the reference three-dimensional space, specifically, a plane where the feature point is located. In the reference plane, a line ML is a cross-sectional line of a three-dimensional structure indicated by the model data 1113. A point S₁ is a point indicating the position of the radar. A position of the point P is a position of the coordinate given by the geocoding unit 113. It is assumed that a distance between the point P and the point S₁ is “R”.

What is reflected to a signal intensity indicated at the point P is the reflected wave from a point such that a distance to the point S₁ is “R” in the cross-sectional view. Specifically, a point associated with the point P is a point such that an arc having the radius “R” with respect to the point S₁ as a center intersects with the line ML. In FIG. 4, points Q₁, Q₂, Q₃, and Q₄ are points, other than the point P, at which an arc having the radius “R” with respect to the point S₁ as a center intersects with the line ML. Therefore, these points Q₁, Q₂, Q₃, and Q₄ are candidate points associated with the point P.

In this way, the candidate point extraction unit 114 may extract, as the candidate point, the point, on the flat plane including the point P and perpendicular to the traveling direction of the radar, at which the distance to the radar is equal to the distance between the radar and the point P.

However, since the point Q₃ is shaded from the point S₁ (is within a so-called radar shadow), contribution of an electromagnetic wave reflected at the point to a signal intensity indicated at the point P may be low. Therefore, candidate points to be extracted by the candidate point extraction unit 114 may be the points Q₁, Q₂, and Q₄, except for the point Q₃. Specifically, the candidate point extraction unit 114 may exclude the point Q₃ from the candidate points based on a line segment connecting the point Q₃ and the point S₁ intersects with the line ML at a point other than the point Q₃.

Information necessary for extraction of the candidate point as described above is a cross-sectional line of the model data 1113, positions of the point S₁ and the point P, and the distance “R” between the point S₁ and the point P, by the flat plane passing through the point P and perpendicular to the azimuth direction in the reference three-dimensional space.

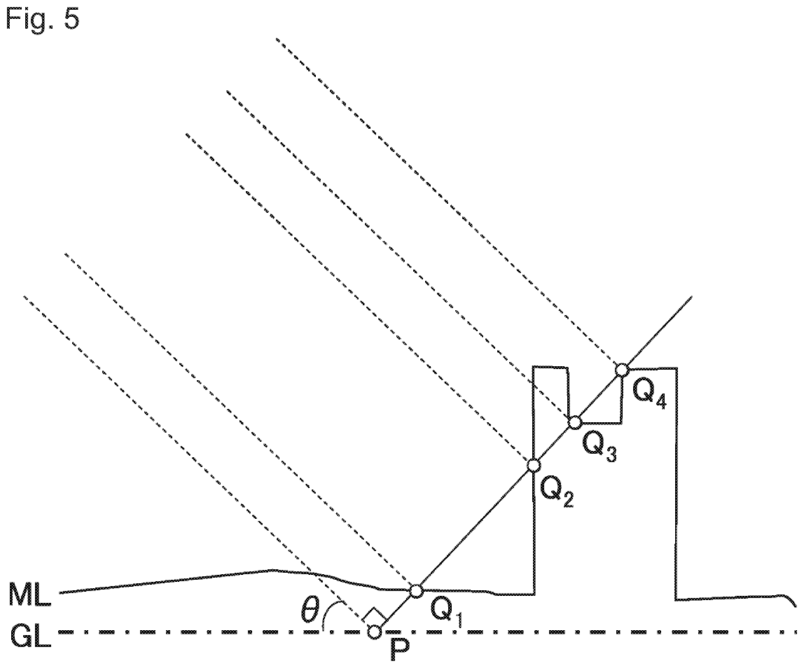

When the point S₁ is sufficiently far, it is possible to approximate in such a way that incident directions of the electromagnetic wave from the point S₁ to the observed object are all parallel to one another. Therefore, as illustrated in FIG. 5, when the point S₁ is sufficiently far, it is possible to specify the candidate point by acquiring an intersection point of a straight line passing through the point P and perpendicular to an incident ray of an electromagnetic wave from the radar to the point P, and the line ML. Note that, in FIG. 5, since a straight line passing through the point Q₃ and parallel to the incident ray of the electromagnetic wave from the radar intersects with the line ML at the point Q₃ (specifically, since the point Q₃ is within a radar shadow), the point Q₃ may be excluded from the candidate points. In this way, the candidate point extraction unit 114 may extract the candidate point, based on approximation that incident directions of the electromagnetic wave from the observation equipment to the observed object are all parallel to one another. In extraction by a method as described above, it is possible to calculate the position of the candidate point by using the azimuth and an angle θ of elevation of the point S₁, in place of the coordinate of the point S₁ and the distance “R”.

The candidate point extraction unit 114 transmits, to the evaluation unit 115 and the output information generation unit 116, the candidate point associated with the feature point.

===Evaluation unit 115===

The evaluation unit 115 performs evaluation with respect to the candidate point extracted by the candidate point extraction unit 114. Specifically, the evaluation unit 115 derives an evaluation value with respect to the candidate point. Further, for example, the evaluation unit 115 associates the evaluation value with information on the candidate point.

Evaluation to be performed by the evaluation unit 115 is evaluation on reliability as an analysis target. For example, as described in the PS-InSAR, it is possible to observe a state of change in terrain by tracking a timewise change of a position of a place at which the reflected signal is emitted. In order to accurately observe a change in terrain, it is a desirable that a place to be tracked is a place at which a scattering characteristic with respect to the radio wave is stable. In other words, reliability as an analysis target can be said to be, for example, a possibility with which a place is a point at which a scattering characteristic with respect to the radio wave is stable.

For example, the evaluation unit 115 may evaluate a possibility with which the candidate point is a place at which a scattering characteristic with respect to the radio wave is stable, as evaluation on the reliability of the candidate point as the analysis target.

Further, as a general idea, when high accuracy analysis is performed by using a measured signal, it is desirable that an intensity of the measured signal is larger. In view of this, the evaluation unit 115 may evaluate, as evaluation on the reliability of the candidate point as the analysis target, a degree of contribution of a signal from the candidate point to an intensity of a signal indicated at the feature point.

Specifically, the evaluation unit 115 performs evaluation as follows, for example.

The evaluation unit 115 derives an evaluation value indicating the reliability with respect to the candidate point based on the geographic information 1114.

As described above, the geographic information 1114 indicates information on a state of the earth's surface. The evaluation unit 115 acquires information on a state at the position of the candidate point based on the geographic information 1114, and derives the evaluation value based on the acquired information. For example, it is assumed that the larger the evaluation value is, the higher the reliability is.

For example, when the geographic information 1114 is information about a value of the NDVI of the earth's surface, the evaluation unit 115 acquires a value of the NDVI at the position of the candidate point. Further, the evaluation unit 115 derives, for example, the evaluation value of the candidate point by an evaluation method in which, as the value of the NDVI decreases, the evaluation value increases. As one example, the evaluation unit 115 may derive, as the evaluation value, an inverse number of the value of the NDVI.

As described above, the NDVI is an index indicating the condition of vegetation on the earth's surface. It is conceived that reflection of the electromagnetic wave is likely to occur at a place at which the value of the NDVI is smaller. Further, as the vegetation is denser, the electromagnetic wave is likely to cause random reflection, and stable backward scattering is less likely to occur.

Therefore, by deriving the evaluation value of the candidate point by the evaluation method in which, as the value of the NDVI decreases, the evaluation value increases, a larger evaluation value is given to a place at which the reliability as the analysis target is higher.

A case where the geographic information 1114 is the NDWI is similarly to the above. Specifically, the evaluation unit 115 may derive the evaluation value of the candidate point by the evaluation method in which, as the value of the NDWI decreases, the evaluation value increases. The NDWI also has a correlation to likelihood of occurring reflection (backward scattering) of the electromagnetic wave. Further, since a shape of a ground containing a large amount of water or a water surface is not stable, the ground or the water surface is not suitable as the analysis target. Therefore, the larger evaluation value is given to a point at which the reliability is higher also by the above-described evaluation method based on the NDWI.

When the evaluation is performed by the evaluation unit 115 as described above, it can be construed that the place at which the evaluation value is large greatly contributes to the intensity of the signal detected by the radar, and is the place at which the scattering characteristic with respect to the electromagnetic wave is stable.

The evaluation unit 115 may derive the evaluation value of the candidate point by using information on a state of the earth's surface, which has a correlation to the reliability, in addition to the NDVI and the NDWI.

For example, the evaluation unit 115 may calculate a luminance gradient of a local area including the candidate point within the optical image by using the optical image in which a predetermined area including the candidate point is displayed, and derive the evaluation value by the evaluation method in which, as the calculated luminance gradient increases, the larger evaluation value is given. Such the evaluation method is based on a premise that, as the luminance gradient increases, unevenness of a surface of the area may increase, and the intensity of the electromagnetic wave reflected in the direction of the radar may be large. Therefore, the evaluation unit 115 can evaluate reliability of the candidate point also by such the evaluation method. Note that, in the evaluation method, the evaluation unit 115 may use a value indicating a variance of luminance, in place of the luminance gradient.

Alternatively, for example, the evaluation unit 115 may derive evaluation, based on the SAR data acquired by measuring the candidate point (different from the SAR data 1111 serving as a processing target by the feature point extraction unit 112). For example, the evaluation unit 115 may derive the evaluation value by the evaluation method in which, as the signal intensity at the candidate point indicated by the SAR data increases, the larger evaluation value is given.

The evaluation unit 115 may derive, after deriving the evaluation value to be derived by the above-described evaluation method as a first evaluation value, a second evaluation value being an evaluation value based on the first evaluation value. The second evaluation value may be, for example, an evaluation value to be derived based on a relationship between the first evaluation value and a predetermined criterion. Specifically, for example, the evaluation unit 115 may derive “B” as the second evaluation value when a value of the first evaluation value is smaller than a value indicated by the predetermined criterion, and derive “A” as the second evaluation value when a value of the first evaluation value is equal to or larger than the value indicated by the predetermined criterion.

Alternatively, the second evaluation value may be an evaluation value to be derived based on a relationship among evaluation values of the plurality of candidate points at which the first evaluation value is calculated. Specifically, for example, the second evaluation value may be a value about an order of largeness of the first evaluation value in a group of candidate points associated with a same feature point.

Alternatively, the second evaluation value may be a value to be acquired by integrating, by averaging or the like, evaluation values derived as the first evaluation values respectively by a plurality of evaluation methods.

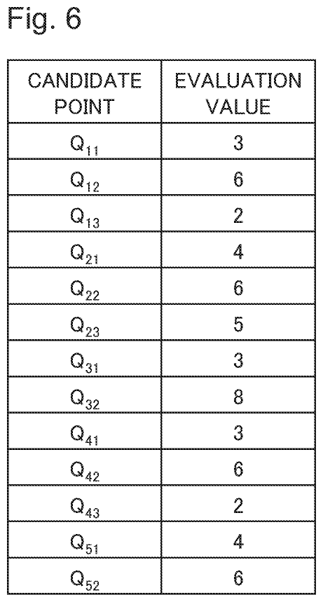

FIG. 6 is a diagram illustrating an example regarding candidate points, and the evaluation value associated with each of the candidate points by the evaluation unit 115. The evaluation unit 115 may generate data as illustrated in FIG. 6, as a result of evaluation.

===Output information generation unit 116===

The output information generation unit 116 generates and outputs information about a result of evaluation performed by the evaluation unit 115.

For example, the output information generation unit 116 generates an image in which the plurality of candidate points are displayed with a display pattern according to the evaluation value. The display pattern is, for example, a pattern of display, which is determined by a shape, a size, a color, brightness, transmissivity, motion of a figure or the like to be displayed, a timewise change of these factors, and the like. Note that, in the present disclosure, “the display pattern of the candidate point” is a display pattern of an indication indicating the position of the candidate point. “Displaying the candidate point” is displaying an indication indicating the position of the candidate point.

In the following, an image in which the plurality of candidate points are displayed with the display pattern according to the evaluation value is described as a point display image. In the description of the present example embodiment, processing of generating a point display image by the output information generation unit 116 is described in detail.

As illustrated in FIG. 3, the output information generation unit 116 includes a display pattern determination unit 1161, a display position determination unit 1162, the image generation unit 1163, and a display control unit 1164. The output information generation unit 116 outputs a point display image through processing by each configuration in the output information generation unit 116.

As a premise, a spatial image being one of spatial images 1115, and information on the position and the evaluation, in the reference three-dimensional space, of the candidate point extracted by the candidate point extraction unit 114 are given to the output information generation unit 116, as input data.

The output information generation unit 116 reads, from the spatial image 1115 stored in the storage unit 111, the spatial image for use in the point display image. The output information generation unit 116 may determine the image to be read based on an instruction from a user, for example. For example, the output information generation unit 116 may accept, from a user, information of designating one of a plurality of spatial images 1115. Alternatively, for example, the output information generation unit 116 may accept information designating an area within the three-dimensional space, and read the spatial image including the designated area.

Alternatively, the output information generation unit 116 may accept information of designating the feature point or the candidate point which a user wishes to display. Further, the output information generation unit 116 may specify an area, in the reference three-dimensional space, which includes the designated feature point or the candidate point, and read the spatial image including the specified area. Note that, the information of designating the feature point or the candidate point which a user wishes to display may be information of designating the SAR data 1111.

The output information generation unit 116 may extract a part of the spatial image 1115 stored in the storage unit 111, and read out the extracted part as the spatial image to be used. For example, when the spatial image is read out based on the candidate point which a user wishes to display, the output information generation unit 116 may extract, from the spatial image 1115, an area including all the candidate points, and read out the extracted image as the spatial image to be used.

The display pattern determination unit 1161 determines the display pattern of the candidate point.

The display pattern determination unit 1161 determines the display pattern, based on the evaluation value given to the candidate point, for each of the candidate points.

The display pattern determination unit 1161 may use data in which a relationship between the evaluation value and the display pattern is defined. Specifically, the display pattern associated with the evaluation value given to the candidate point in the above-described data may be specified, and the specified display pattern may be determined as the display pattern of the candidate point.

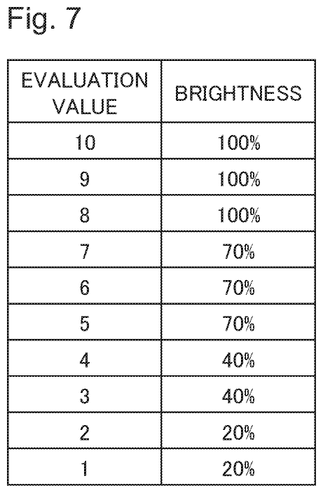

FIG. 7 is a diagram illustrating an example of data in which the relationship between the evaluation value and the display pattern is defined. The example of FIG. 7 illustrates a relationship between each of evaluation values and brightness of display, when the evaluation value is given by an integer in a range from 1 to 10. In a case based on such table, for example, the display pattern determination unit 1161 determines opaqueness of display indicating the position of the candidate point at which the evaluation value is “5” as “70%”. Note that, opaqueness is a scale indicating a degree of contribution of a pixel value of a figure to the pixel value of a position at which the figure is superimposed, when the figure to be displayed is superimposed on an image. As opaqueness decreases, the contribution of the pixel value of a figure to a position at which the figure is displayed decreases.

Alternatively, the display pattern determination unit 1161 may determine the display pattern which varies according to the evaluation value by deriving a parameter relating to the display pattern by calculation using the evaluation value.

For example, the display pattern determination unit 1161 may calculate saturation of display of the candidate point by a formula: evaluation value/10. In this way, the display pattern determination unit 1161 may calculate saturation of display of the candidate point by a calculation method in which, as the evaluation value increases, saturation increases.

The parameter relating to the display pattern is not limited to the opaqueness and the saturation. The parameter which is set according to the evaluation value may be, for example, any of parameters which define a shape, a size, a color, brightness, transmissivity, motion of a figure or the like to be displayed, a timewise change of these factors, and the like, as the display pattern.

The display pattern determination unit 1161 may determine the display pattern in such a way that display of the candidate point to which the large evaluation value is given is displayed more distinguishably, for example.

The display position determination unit 1162 determines a display position of the candidate point to be displayed in the point display image. The display position determination unit 1162 specifies the position of the candidate point within the spatial image by, for example, calculation based on the capturing condition information.

For example, the display position determination unit 1162 specifies a capturing area and a capturing direction of the spatial image, based on the capturing condition information. Further, the display position determination unit 1162 acquires a section of the capturing area, which is cut by a flat plane including the candidate point and perpendicular to the capturing direction. A positional relationship between the section and the candidate point is equivalent to a positional relationship between the spatial image and the candidate point. The display position determination unit 1162 may specify the coordinate of the candidate point, when a coordinate of the section is associated with a coordinate of the spatial image. The specified coordinate is a coordinate of the candidate point within the spatial image.

Note that, an optical satellite image may be corrected by the ortho-correction or the like. When the optical satellite image is corrected, a position indicated by the candidate point is also corrected. The position of the candidate point may be corrected by using a correction parameter used in correcting the optical satellite image.

A method of specifying the position of the candidate point within the spatial image as described above is one example. The display position determination unit 1162 may specify the position of the candidate point within the spatial image, based on the position of the candidate point in the reference coordinate system, and the relationship between the spatial image and the reference coordinate system.

The image generation unit 1163 generates the point display image. Specifically, the image generation unit 1163 generates, as the point display image, an image in which the indication indicating the position of the candidate point is superimposed on the spatial image. Note that, in the present disclosure, “generating an image” is generating data for displaying an image. A format of data to be generated by the image generation unit 1163 is not limited to an image format. The image to be generated by the image generation unit 1163 needs only to be data including information necessary for the display device 21 to display.

The image generation unit 1163 superimposes the indication to be displayed with the display pattern determined by the display pattern determination unit 1161 on the spatial image at the position determined by the display position determination unit 1162. Thus, the spatial image in which the candidate point is displayed, specifically, the point display image is generated.

The display control unit 1164 performs control of causing the display device 21 to display the point display image generated by the image generation unit 1163. The display control unit 1164 causes the display device 21 to display the point display image by outputting the point display image to the display device 21, for example.

===Display device 21===

The display device 21 displays information received from the display control unit 1164.

The display device 21 is, for example, a display such as a liquid crystal monitor, or a projector. The display device 21 may have a function as an input unit, like a touch panel. In description of the present example embodiment, the display device 21 is connected to the information processing device 11 as an external device of the information processing device 11. Alternatively, the display device 21 may be included in the information processing device 11 as a display unit.

A browser who views the display by the display device 21 recognizes a result of processing by the information processing device 11. Specifically, the browser is able to observe the point display image generated by the image generation unit 1163.

<Operation>

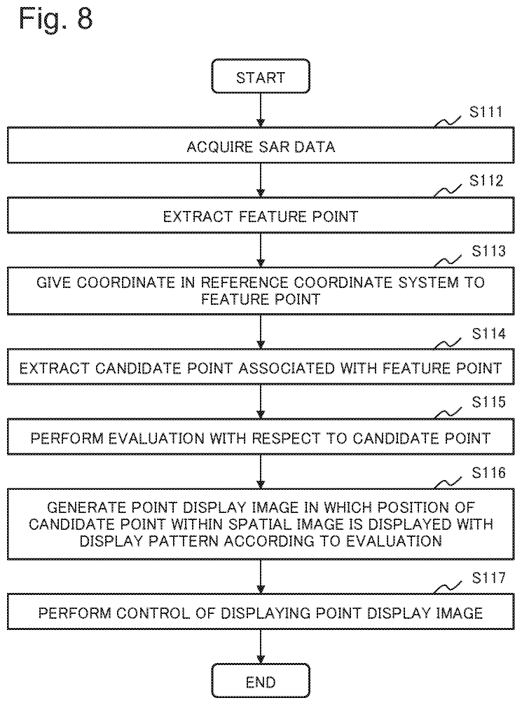

An example of a flow of processing by the information processing device 11 is described in accordance with a flowchart of FIG. 8.

The feature point extraction unit 112 of the information processing device 11 acquires the SAR data 1111 from the storage unit 111 (Step S111). The SAR data 1111 to be acquired includes at least SAR data in an area included in the spatial image to be used in Step S117 to be described later.

Further, the feature point extraction unit 112 extracts the feature point from the acquired SAR data 1111 (Step S112).

Next, the geocoding unit 113 gives, to the extracted feature point, the coordinate indicating the position in the reference coordinate system of the feature point (Step S113). The geocoding unit 113 transmits, to the candidate point extraction unit 114, the coordinate given to the extracted feature point.

Next, the candidate point extraction unit 114 extracts the candidate point associated with the feature point based on the coordinate of the feature point and the model data 1113 (Step S114). Specifically, the candidate point extraction unit 114 specifies the coordinate of the candidate point associated with the feature point. Further, the candidate point extraction unit 114 transmits, to the evaluation unit 115 and the output information generation unit 116, the coordinate of the candidate point. The candidate point extraction unit 114 may store, in the storage unit 111, the coordinate of the candidate point, in a format in which the feature point and the candidate point are associated with each other.

Next, the evaluation unit 115 performs the evaluation with respect to the candidate point (Step S115). Further, the evaluation unit 115 transmits, to the output information generation unit 116, information about the evaluation with respect to the candidate point.

Further, the output information generation unit 116 generates the point display image in which the position of the candidate point within the spatial image is displayed with the display pattern according to the evaluation (Step S116).

Specifically, for example, in the output information generation unit 116, the display pattern determination unit 1161 determines the display pattern of each of candidate points based on the evaluation given by the evaluation unit 115. Further, the display position determination unit 1162 determines the display position of the candidate point within the spatial image based on the position of the candidate point, the capturing condition information, and the model data 1113. Further, the image generation unit 1163 generates the point display image being the spatial image in which the candidate point is displayed based on the determined display pattern and the determined position.

Note that, the output information generation unit 116 reads out, from the storage unit 111, the spatial image to be used in generating the point display image, when processing of Step S116 is performed.

Note that, a timing at which the spatial image to be read out by the output information generation unit 116 is determined may be before or after a timing when processing of acquiring the SAR data is performed. Specifically, in one example, the information processing device 11 may specify, after determining the spatial image to be used, the SAR data 1111 being data acquired by measuring an area including an area included in the determined spatial image, and acquire the specified SAR data 1111 in Step S111.

Further, in one example, the information processing device 11 may perform in advance, before determining the spatial image to be used, processing from Steps S111 to S115 with respect to the SAR data 1111 in an area inclusive in the spatial image 1115. Information to be generated in each processing from Steps S112 to S115 may be stored in the storage unit 111, for example.

When the spatial image to be read out by the output information generation unit 116 is determined, the output information generation unit 116 may determine the candidate point to be displayed by specifying the candidate point included in an area of the spatial image based on the capturing condition information.

Further, the display control unit 1164 of the output information generation unit 116 performs control of displaying the generated point display image (Step S118). Thus, the display device 21 displays the point display image.

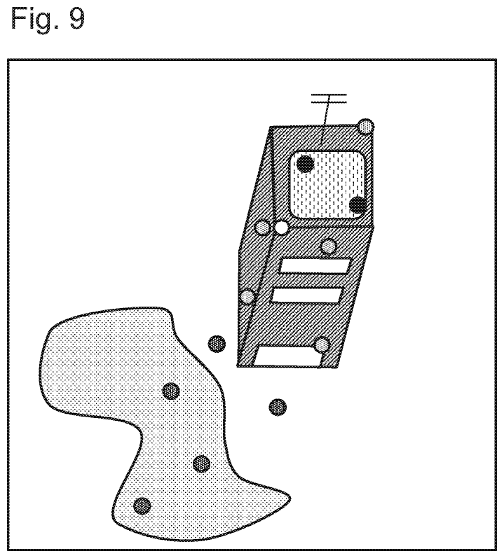

FIG. 9 is one example of the point display image to be generated by the information processing device 11 and displayed by the display device 21. Thirteen small circles indicating positions of thirteen candidate points are displayed with display patterns according to evaluation values, respectively. In the example of FIG. 9, brightness of a figure to be displayed at a position of each of the candidate points is associated with the evaluation value. For example, when the browser knows that, as brightness increases, the evaluation increases, the browser can easily recognize the candidate point having high evaluation, specifically, the candidate point having high reliability by a display as described above.

### Advantageous Effect

In the information processing device 11 according to the first example embodiment, the browser can easily comprehend, in the SAR image, a place which contributes to a signal at a point within a region where the layover occurs. A reason for this is that the candidate point extraction unit 114 extracts based on the model data 1113, the candidate point being a place which may have contributed to a signal at the feature point, and the image generation unit 1163 generates a point display image being the spatial image in which the candidate point is displayed.

By the evaluation unit 115 and the output information generation unit 116, a user of the information processing device 11 is provided with information about the evaluation with respect to the candidate point. In the present example embodiment, a user can view the point display image in which a plurality of candidate points are displayed with the display pattern according to the evaluation by the evaluation unit 115. Thus, a browser can easily recognize the candidate point having high evaluation, specifically, having high reliability as the analysis target among the plurality of candidate points. This advantageous effect is conspicuous when the candidate point to which a large evaluation value is given is displayed more distinguishably.

Further, when the feature point is the permanent scatterer, information on the evaluation given to the candidate point associated with the feature is useful in analyzing a change in terrain. Specifically, for example, when two or more candidate points associated with the permanent scatterer are present, the browser can easily determine which one of the candidate points is a place at which stable scattering reflection actually occurs. Further, the browser can acquire accurate information relating to a change in terrain by observing a displacement of the permanent scatterer by using the SAR data 1111 by a plurality of measurements.

### Modification Example 1

In the operation example of the above-described information processing device 11, the order of processing of Step S111 and processing of Step S112 may be reversed. Specifically, the feature point extraction unit 112 may extract the feature point from among points to which the coordinate is given by the geocoding unit 113.

### Modification Example 2

The image generation unit 1163 may generate the point display image in which the candidate point having highest evaluation among a plurality of candidate points which contribute to a signal at the same feature point is displayed with a most distinguished display pattern. By such a configuration, the browser can easily recognize the candidate point having highest reliability among the plurality of candidate points which contribute to the signal at the same feature point.

### Modification Example 3

The output information generation unit 116 may exclude, from the candidate point to be displayed, the candidate point having the evaluation value equal to or smaller than a predetermined threshold value. Specifically, the output information generation unit 116 may specify, from the candidate point extracted by the candidate point extraction unit 114, which is included in an area included in the spatial image, the candidate point having the evaluation value larger than the predetermined threshold value. Further, the output information generation unit 116 may generate the point display image in which only the specified candidate point is displayed.

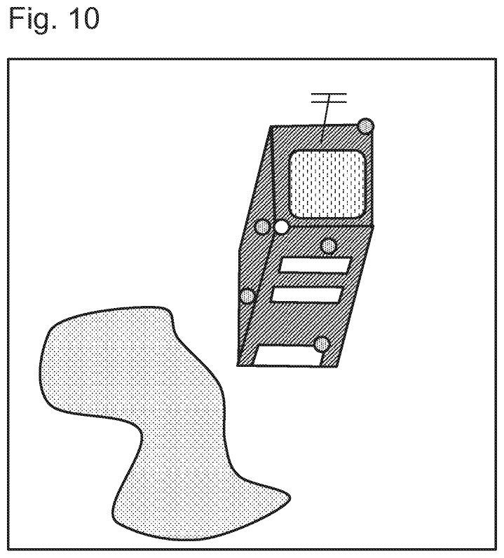

FIG. 10 is an example of a point display image in which only the candidate point having the evaluation value larger than a predetermined threshold value is displayed. In this way, by sorting out the candidate point to be displayed, the browser can pay attention only to information on the candidate point having high evaluation.

### Modification Example 4

The display pattern determination unit 1161 may further be configured to determine the display pattern in such a way that the display pattern of the candidate point associated with the specific feature point is different from the display pattern of another candidate point.

For example, the display pattern determination unit 1161 may determine the display pattern in such a way that the candidate point associated with the feature point designated by a user is displayed in white, and other candidate points are displayed in black.

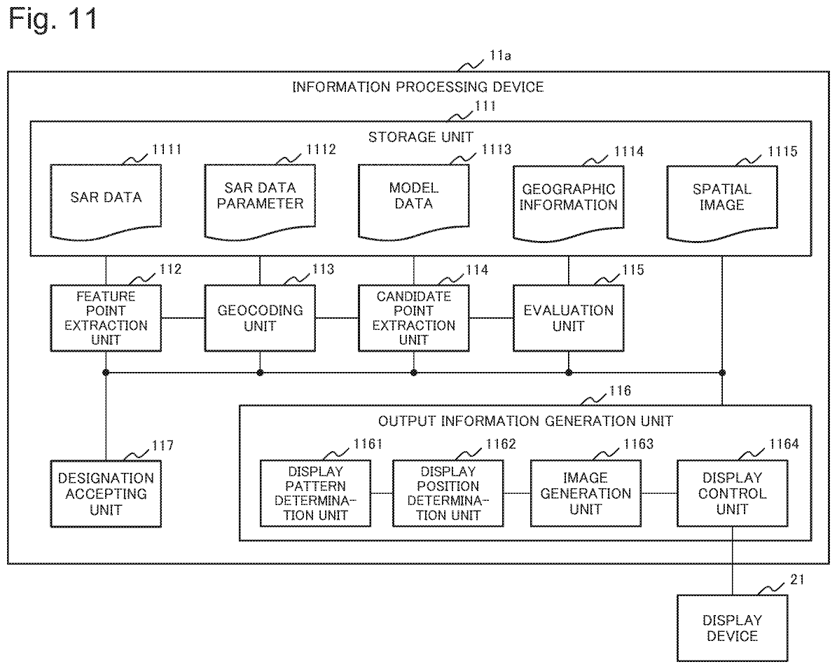

Designation of the feature point by a user is, for example, performed by a designation accepting unit 117. FIG. 11 is a block diagram illustrating a configuration of an information processing device 11a including the designation accepting unit 117.

The designation accepting unit 117 accepts, for example, designation of the feature point from a user of the information processing device 11a. For example, the information processing device 11a may display, on the display device 21, the SAR image in which the feature point is displayed. Further, the designation accepting unit 117 may accept user's selection of one or more feature points from feature points displayed in the SAR image. The selection may be performed via an input-output device such as a mouse. The selected feature point is a designated feature point. The designation accepting unit 117 may accept designation of the plurality of feature points.

The designation accepting unit 117 transmits, to the output information generation unit 116, information on the designated feature point. Information on the designated feature point is, for example, an identification number, the coordinate, or the like, which is associated with each of the feature points.

The output information generation unit 116 specifies the candidate point associated with the designated feature point. The output information generation unit 116 may cause the candidate point extraction unit 114 to extract the candidate point associated with the designated feature point, and accept information on the extracted candidate point, for example. Alternatively, when information in which the feature point and the candidate point are associated with each other is stored in the storage unit 111, the output information generation unit 116 may specify the candidate point, based on the information.

The designation accepting unit 117 may accept designation of the candidate point, in place of designation of the feature point. For example, a user may select any one of candidate points from among the candidate points included in the point display image displayed by processing of Step S117. The designation accepting unit 117 may accept the selection, and specify the feature point associated with the selected candidate point. Further, the designation accepting unit 117 may specify the candidate point associated with the feature point.

In the output information generation unit 116, the display pattern determination unit 1161 determines, as the display pattern of the specified candidate point, the display pattern different from the display pattern of another candidate point. Further, the image generation unit 1163 generates the point display image in which the candidate point by the determined display pattern is displayed. By causing the display device 21 to display the point display image, the browser can view information on the candidate point associated with the designated feature point.

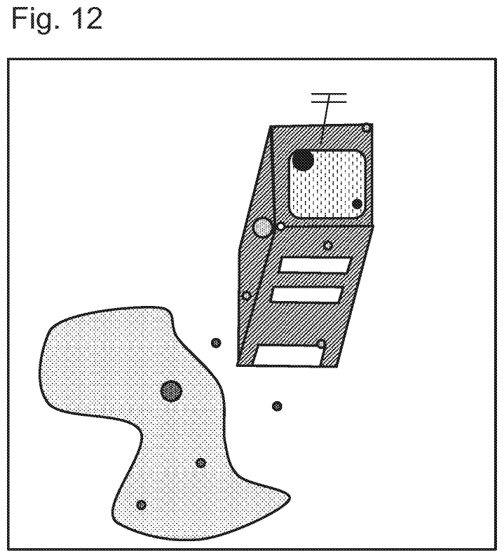

FIG. 12 is a diagram illustrating an example of the point display information to be generated by the information processing device 11a according to the present modification example 4. In FIG. 12, a size of display of the candidate point associated with the specific feature point is larger than a size of display of another candidate point.

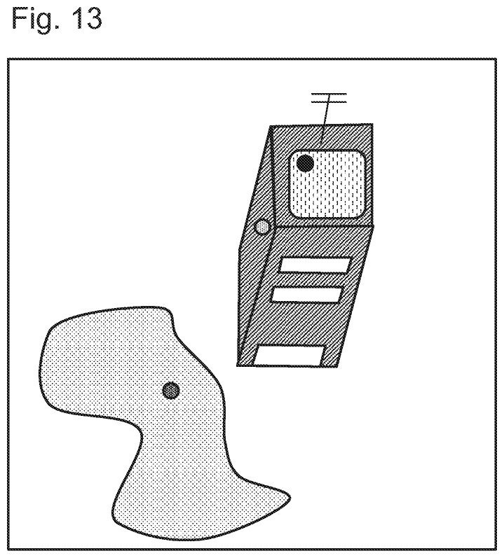

FIG. 13 is a diagram illustrating another example of the point display image to be generated by the information processing device 11a according to the present modification example 4. In FIG. 13, only the candidate point associated with the specific feature point is displayed.

According to a display as described above, the browser can more clearly comprehend the candidate point. Specifically, the browser can compare the evaluation among candidate points associated with the specific feature point. The browser can recognize the degree of contribution of the displayed candidate point to the signal at the specific feature point, for example.

### Second Example Embodiment

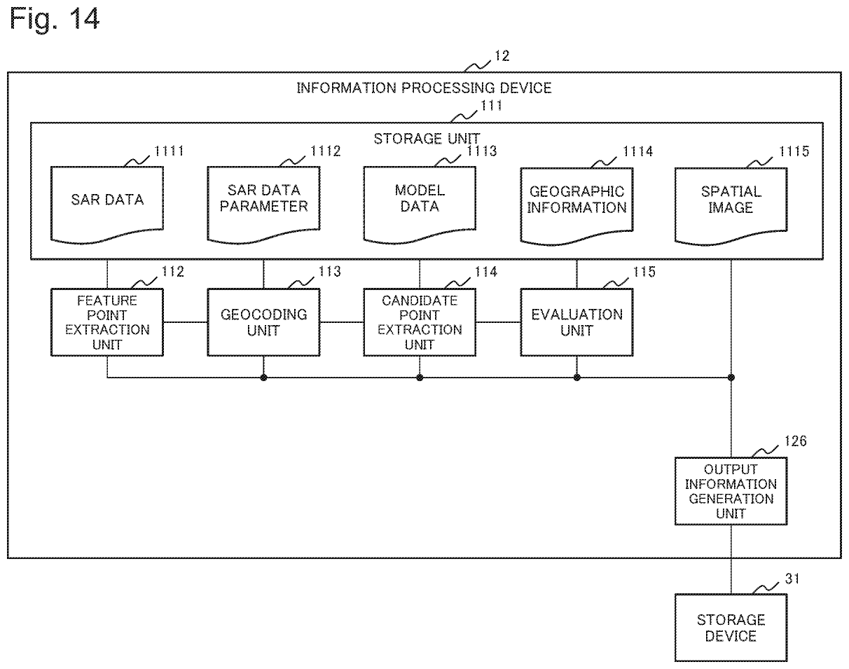

An information processing device 12 according to a second example embodiment of the present invention is described. FIG. 14 is a block diagram illustrating a configuration of the information processing device 12. The information processing device 12 is connected to a storage device 31, in place of the display device 21. Further, the information processing device 12 includes an output information generation unit 126, in place of the output information generation unit 116. The configuration of the information processing device 12 other than the above is similar to the configuration of the information processing device 11.

The storage device 31 is a device for storing information. The storage device 31 is, for example, a hard disk, a portable memory, or the like.

The output information generation unit 126 generates output data for outputting information about a relationship between the evaluation by the evaluation unit 115 and the candidate point. For example, the output information generation unit 126 generates the point display image in which the specified candidate point is displayed with a pattern different from a pattern of another candidate point. Further, for example, the output information generation unit 126 generates a data set about a relationship between the candidate point and the evaluation value. The data set to be generated is, for example, data in a table format.

The output information generation unit 126 outputs, to the storage device 31, the generated output data. Thus, the storage device 31 stores information generated by the information processing device 12.

The storage device 31 may output the stored information to another information processing device.

The present example embodiment also provides useful information about a place which contributes to the signal at the point within a region where the layover occurs in the intensity map of the signal from the observed object acquired by the radar.

### Third Example Embodiment

An information processing device 10 according to one example embodiment of the present invention is described.

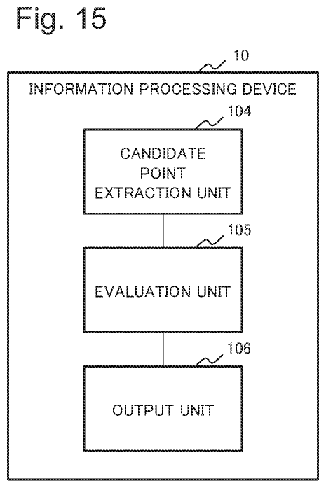

FIG. 15 is a block diagram illustrating a configuration of the information processing device 10. The information processing device 10 includes the candidate point extraction unit 104, an evaluation unit 105, and an output unit 106.

The candidate point extraction unit 104 extracts, based on a position, in a three-dimensional space, of a target point being a point to be specified in an intensity map of a signal from an observed object acquired by a radar, and a shape of the observed object, a candidate point being a point which contributes to the signal at the target point. The candidate point extraction unit 114 according to each of the above-described example embodiments is one example of the candidate point extraction unit 104.

The signal is, for example, a signal of a reflected wave of a radio wave transmitted from the radar. The intensity map of the signal is, for example, a SAR image. The point to be specified in the intensity map is associated with one place in the three-dimensional space. One example of the target point is the feature point in the first example embodiment. Note that, the shape of the observed object is, for example, given by three-dimensional model data.

The evaluation unit 105 performs, with respect to the candidate point extracted by the candidate point extraction unit 104, evaluation on reliability regarding analysis with respect to the signal emitted at the candidate point based on geographic information indicating a state of the earth's surface including the candidate point.

The evaluation unit 115 according to each of the above-described example embodiments is one example of the evaluation unit 105.

The output unit 106 outputs information indicating a result of the evaluation by the evaluation unit 105. For example, the output unit 106 generates a point display image in which the candidate point is displayed with a display pattern according to a result of evaluation in a spatial image.

The display control unit 1164, the output information generation unit 126, and the display device 21 according to each of the above-described example embodiments are one example of the output unit 106.

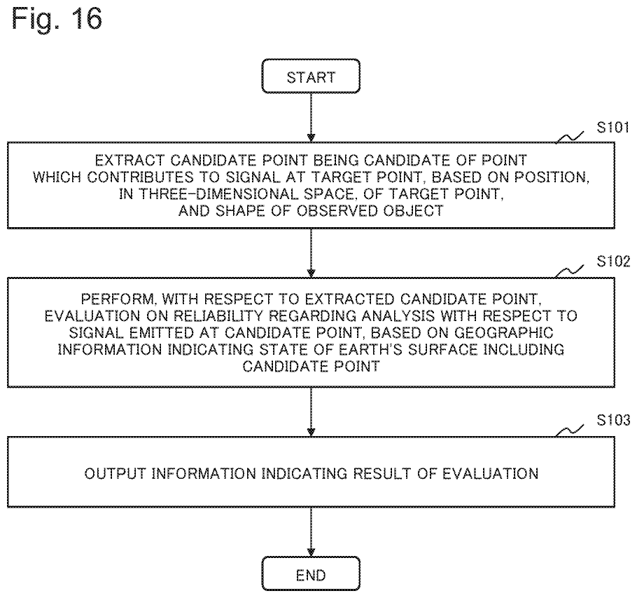

FIG. 16 is a flowchart illustrating a flow of an operation by the information processing device 10.

The candidate point extraction unit 104 extracts, based on the position in the three-dimensional space, of the target point being a point to be specified in the intensity map, and a shape of the observed object, the candidate point being a point which contributes to the signal at the target point (Step S101).

Next, the evaluation unit 105 performs, with respect to the candidate point extracted by the candidate point extraction unit 104, the evaluation on the reliability regarding analysis with respect to the signal emitted at the candidate point based on the geographic information indicating a state of the earth's surface including the candidate point (Step S102).

Further, the output unit 106 outputs the information about the result of the evaluation by the evaluation unit 105 (Step S103).

According to the present configuration, it is easy to comprehend a point, on the observed object, which contributes to the signal at the point within a region where the layover occurs in the intensity map of the signal from the observed object acquired by the radar. A reason for this is that the candidate point extraction unit 104 extracts the candidate point which contributes to the signal at the target point, based on model data, the evaluation unit 105 performs the evaluation with respect to the candidate point, and the output unit 106 outputs the result of the evaluation.

<Hardware Configuration for Achieving Each Unit of Example Embodiment>

In the example embodiments according to the present invention described above, each constituent element of each device indicates a block of a function unit.

Processing of each constituent element may be achieved, for example, by a computer system by reading and executing a program stored in a computer readable storage medium and causing the computer system to execute the processing. The “computer readable storage medium” is, for example, a portable medium such as an optical disc, a magnetic disk, a magneto-optical disk, and a non-volatile semiconductor memory; and a storage device such as a read only memory (ROM) and a hard disk to be built in a computer system. The “computer readable storage medium” includes a medium for dynamically storing a program for a short time, like a communication line when the program is transmitted via a network such as the Internet or a communication line such as a telephone line; and a medium for temporarily storing the program, like a volatile memory within a computer system equivalent to a server or a client in the above-described case. Further, the program may be a program for achieving a part of the above-described function, or may be a program capable of achieving the above-described function by combination with a program that is already stored in the computer system.

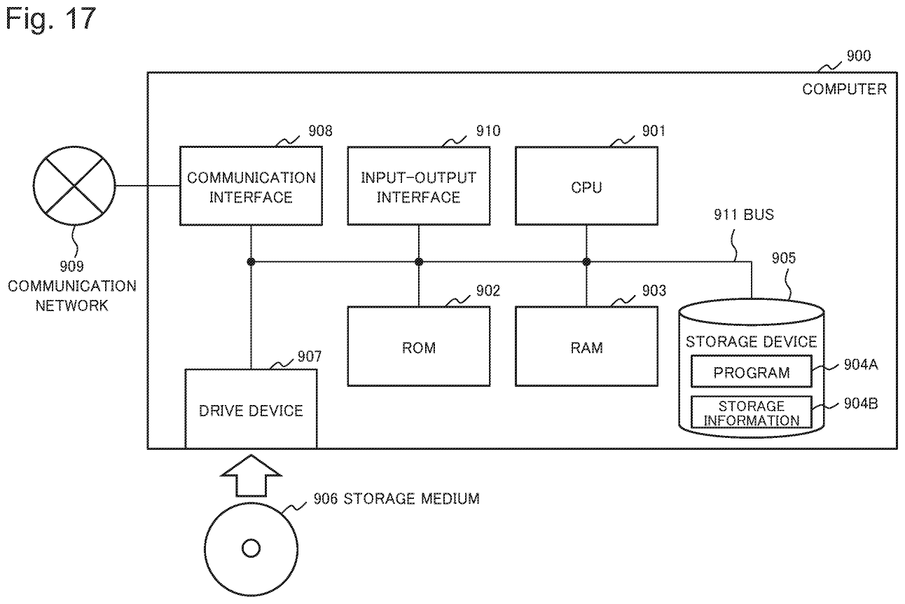

The “computer system” is, as one example, a system including a computer 900 as illustrated in FIG. 17. The computer 900 includes the following configuration.
A central processing unit (CPU) 901
A ROM 902
A random access memory (RAM) 903
A program 904A and storage information 904B to be loaded in the RAM 903
A storage device 905 for storing the program 904A and the storage information 904B
A drive device 907 for reading and writing to and from a storage medium 906
A communication interface 908 to be connected to a communication network 909
An input-output interface 910 for performing input and output of data
A bus 911 to be connected to each constituent element

For example, each constituent element of each device in each of the example embodiments is achieved by causing the CPU 901 to load the program 904A for achieving a function of the constituent element on the RAM 903 and execute the program 904A. The program 904A for achieving a function of each constituent element of each device is, for example, stored in advance in the storage device 905 or the ROM 902. Then, the CPU 901 reads the program 904A as necessary. The storage device 905 is, for example, a hard disk. The program 904A may be supplied to the CPU 901 via the communication network 909; or may be stored in advance in the storage medium 906, read by the drive device 907, and supplied to the CPU 901. Note that, the storage medium 906 is, for example, a portable medium such as an optical disc, a magnetic disk, a magneto-optical disk, and a non-volatile semiconductor memory.

Various modification examples are available as a method of achieving each device. For example, each device may be achieved, for each of constituent elements, by combination of each of individual computers 900 and a program. Further, a plurality of constituent elements included in each device may be achieved by combination of one computer 900 and a program.

Further, a part or all of each constituent element of each device may be achieved by another general-purpose or dedicated circuit, a computer, or combination of these elements. The elements may be constituted by a single chip, or may be constituted by a plurality of chips to be connected via a bus.

When a part or all of each constituent element of each device is achieved by a plurality of computers, circuits, or the like, the plurality of computers, circuits, or the like may be concentratedly disposed or may be distributedly disposed. For example, a computer, a circuit, or the like may be achieved as a configuration in which each of a client-and-server system, a cloud computing system, and the like is connected via a communication network.

The invention of the present application is not limited to the above-described example embodiments. A configuration and details of the invention of the present application may be changed in various ways comprehensible to a person skilled in the art within the scope of the invention of the present application.

A part or the entirety of the above-described example embodiments may be described as the following supplementary notes, but are not limited to the following.

<<Supplementary Notes>>

[Supplementary note 1]

An information processing device includes:

candidate point extraction means for extracting a candidate point based on a position of a target point in a three-dimensional space and a shape of an observed object, the target point being a point to be specified in an intensity map of a signal acquired from the observed object by a radar, the candidate point being a point which contributes to the signal at the target point;

evaluation means for performing evaluation on reliability regarding analysis with respect to the signal emitted at the candidate point based on geographic information about a state of the earth's surface including the candidate point; and

output means for outputting information about a result of the evaluation.

### [Supplementary Note 2]

The information processing device according to supplementary note 1, further includes

image generation means for generating a point display image, the point display image being an image in which a plurality of candidate points are displayed in a spatial image in which the observed object is displayed with a display pattern of each of the plurality of candidate points, the display pattern being a pattern according to a result of the evaluation, wherein

the output means outputs the point display image.

### [Supplementary Note 3]

In the information processing device according to supplementary note 2, wherein

the image generation means generates the point display image in which the candidate point is displayed with a more distinguished display pattern, as the reliability of the candidate point increases.

### [Supplementary Note 4]

In the information processing device according to supplementary note 3, wherein

the image generation means generates the point display image in which the candidate point having the highest reliability among the plurality of candidate points which contribute to the signal at the same feature point is displayed with a most distinguished display pattern.

[Supplementary note 5]

In the information processing device according to any one of supplementary notes 1 to 4, wherein

the output means specifies the candidate point which extracted by the candidate point extraction means and at which a value indicating the reliability is larger than a predetermined threshold value, and outputs information on the candidate point specified.

### [Supplementary Note 6]

In the information processing device according to any one of supplementary notes 1 to 5, wherein

the geographic information is information in which an index value indicating stability of backward scattering with respect to a radio wave is associated with the earth's surface.

### [Supplementary Note 7]

In the information processing device according to supplementary note 6, wherein the index value is a value indicating a condition of vegetation on the earth's surface.

### [Supplementary Note 8]

In the information processing device according to any one of supplementary notes 1 to 5, wherein the geographic information includes information indicating an intensity of light or a radio wave to be reflected on the earth's surface.

### [Supplementary Note 9]

An information processing method includes:

extracting a candidate point based on a position of a target point in a three-dimensional space and a shape of an observed object, the target point being a point to be specified in an intensity map of a signal acquired from the observed object by a radar, the candidate point being a point which contributes to the signal at the target point;

performing evaluation on reliability regarding analysis with respect to the signal emitted at the candidate point based on geographic information about a state of the earth's surface including the candidate point; and

outputting information about a result of the evaluation.

### [Supplementary Note 10]

The information processing method according to supplementary note 9, further includes

generating a point display image, the point display image being an image in which a plurality of candidate points are displayed in a spatial image in which the observed object is displayed with a display pattern of each of the plurality of candidate points, the display pattern being a pattern according to a result of the evaluation, and outputting the point display image.

### [Supplementary Note 11]

The information processing method according to supplementary note 10, further comprising

generating the point display image in which the candidate point is displayed with a more distinguished display pattern, as the reliability of the candidate point increases.

### [Supplementary Note 12]

The information processing method according to supplementary note 11, further includes

generating the point display image in which the candidate point having the highest reliability among the plurality of candidate points which contribute to the signal at the same feature point is displayed with a most distinguished display pattern.

### [Supplementary Note 13]

The information processing method according to any one of supplementary notes 9 to 12, further includes

specifying the extracted candidate point, and at which a value indicating the reliability is larger than a predetermined threshold value and

outputting information on the candidate point specified.

### [Supplementary Note 14]

In the information processing method according to any one of supplementary notes 9 to 13, wherein

the geographic information is information in which an index value indicating stability of backward scattering with respect to a radio wave is associated with the earth's surface.

### [Supplementary Note 15]

In the information processing method according to supplementary note 14, wherein the index value is a value indicating a condition of vegetation on the earth's surface.

### [Supplementary Note 16]

In the information processing method according to any one of supplementary notes 9 to 13, wherein the geographic information includes information indicating an intensity of light or a radio wave to be reflected on the earth's surface.

### [Supplementary Note 17]

A computer readable storage medium stores a program causing a computer to execute:

extracting a candidate point based on a position of a target point in a three-dimensional space and a shape of an observed object, the target point being a point to be specified in an intensity map of a signal acquired from the observed object by a radar, the candidate point being a point which contributes to the signal at the target point;

performing evaluation on reliability regarding analysis with respect to the signal emitted at the candidate point, based on geographic information about a state of the earth's surface including the candidate point; and

outputting information about a result of the evaluation.

### [Supplementary Note 18]

In the storage medium according to supplementary note 17, wherein

the program causes the computer to further execute:

generating a point display image, the point display image being an image in which a plurality of candidate points are displayed in a spatial image in which the observed object is displayed with a display pattern of each of the plurality if candidate points, the display pattern being a pattern according to a result of the evaluation, and

outputting the point display image

### [Supplementary Note 19]

The storage medium according to supplementary note 18, wherein

the point display image is an image in which the candidate point is displayed with a more distinguished display pattern, as the reliability of the candidate point increases.

### [Supplementary Note 20]

In the storage medium according to supplementary note 19, wherein

the point display image is an image in which the candidate point having the highest reliability among the plurality of candidate points which contribute to the signal at the same feature point is displayed with a most distinguished display pattern.

### [Supplementary Note 21]

In the storage medium according to any one of supplementary notes 17 to 20, wherein the program causes the computer to further execute

specifying the extracted candidate point and at which a value indicating the reliability is larger than a predetermined threshold value, and

outputting information on the candidate point specified.

### [Supplementary Note 22]

In the storage medium according to any one of supplementary notes 17 to 21, wherein

the geographic information is information in which an index value indicating stability of backward scattering with respect to a radio wave is associated with the earth's surface.

### [Supplementary Note 23]

In the storage medium according to supplementary note 22, wherein the index value is a value indicating a condition of vegetation on the earth's surface.

### [Supplementary Note 24]

In the storage medium according to any one of supplementary notes 17 to 21, wherein the geographic information includes information indicating an intensity of light or a radio wave to be reflected on the earth's surface.

### REFERENCE SIGNS LIST

10, 11 Information processing device
104 Candidate point extraction unit
105 Evaluation unit
106 Output unit
111 Storage unit
112 Feature point extraction unit
113 Geocoding unit
114 Candidate point extraction unit
115 Evaluation unit
116, 126 Output information generation unit
1161 Display pattern determination unit
1162 Display position determination unit
1163 Image generation unit
1164 Display control unit
117 Designation accepting unit
1111 SAR data
1112 SAR data parameter
1113 Model data
1114 Geographic information
1115 Spatial image
21 Display device
31 Storage device
900 Computer
901 CPU
902 ROM
903 RAM
904A Program
904B Storage information
905 Storage device
906 Storage medium
907 Drive device
908 Communication interface
909 Communication network
910 Input-output interface
911 Bus

What is claimed is:

1. An information processing device comprising:
a memory; and
at least one processor coupled to the memory,
the at least one processor performing operations to:
extract a candidate point from an observed object based on a position of a target point in a three-dimensional space and a shape of the observed object, the target point being a point to be specified in an intensity map of a signal acquired from the observed object by a radar, the candidate point being a point which contributes to the signal at the target point;
perform evaluation on reliability regarding analysis with respect to the signal emitted at the candidate point based on geographic information about a state of the earth's surface including the candidate point; and
output information about a result of the evaluation.

2. The information processing device according to claim 1, wherein the at least one processor further performs operations to:
generate a point display image, the point display image being an image in which a plurality of the candidate points are displayed in a spatial image in which the observed object is displayed with a display pattern of each of the plurality of the candidate points, the display pattern being a pattern according to a result of the evaluation; and
output the point display image.

3. The information processing device according to claim 2, wherein
the point display image is an image in which the candidate point is displayed with a more distinguished display pattern, as the reliability of the candidate point increases.

4. The information processing device according to claim 3, wherein
the point display image is an image in which the candidate point having the highest reliability among the plurality of the candidate points which contribute to the signal at the same target point is displayed with a most distinguished display pattern.

5. The information processing device according to claim 1, wherein the at least one processor further performs operations to:
specify the extracted candidate point and at which a value indicating the reliability is larger than a predetermined threshold value, and
output information on the candidate point specified.

6. The information processing device according to claim 1, wherein
the geographic information is information in which an index value indicating stability of backward scattering with respect to a radio wave is associated with the earth's surface.

7. The information processing device according to claim 6, wherein the index value is a value indicating a condition of vegetation on the earth's surface.

8. The information processing device according to claim 1, wherein the geographic information includes information indicating an intensity of light or a radio wave to be reflected on the earth's surface.

9. An information processing method comprising:
by at least one processor,
extracting a candidate point from an observed object based on a position of a target point in a three-dimensional space and a shape of the observed object, the target point being a point to be specified in an intensity map of a signal acquired from the observed object by a radar, the candidate point being a point which contributes to the signal at the target point;
performing evaluation on reliability regarding analysis with respect to the signal emitted at the candidate point based on geographic information about a state of the earth's surface including the candidate point; and
outputting information about a result of the evaluation.

10. The information processing method according to claim 9, further comprising,
by the at least one processor,
generating, a point display image, the point display image being an image in which a plurality of the candidate points are displayed in a spatial image in which the observed object is displayed with a display pattern of each of the plurality of candidate points, the display pattern being a pattern according to a result of the evaluation, and outputting the point display image.

11. The information processing method according to claim 10, further comprising,
by the at least one processor,
generating the point display image in which the candidate point is displayed with a more distinguished display pattern, as the reliability of the candidate point increases.

12. The information processing method according to claim 11, further comprising,
by the at least one processor,
generating the point display image in which the candidate point having the highest reliability among the plurality of the candidate points which contribute to the signal at the same target point is displayed with a most distinguished display pattern.

13. The information processing method according to claim 9, further comprising,
by the at least one processor,
specifying the extracted candidate point and at which a value indicating the reliability is larger than a predetermined threshold value, and
outputting information on the candidate point specified.

14. The information processing method according to claim 9, wherein
the geographic information is information in which an index value indicating stability of backward scattering with respect to a radio wave is associated with the earth's surface.

15-16. (canceled)

17. A non-transitory computer readable storage medium storing a program causing a computer to execute:
extracting a candidate point from an observed object based on a position of a target point in a three-dimensional space and a shape of the observed object, the target point being a point to be specified in an intensity map of a signal acquired from the observed object by a radar, the candidate point being a point which contributes to the signal at the target point;
performing evaluation on reliability regarding analysis with respect to the signal emitted at the candidate point based on geographic information about a state of the earth's surface including the candidate point; and
outputting information about a result of the evaluation.

18. The non-transitory storage medium according to claim 17, wherein
the program causes the computer to further execute:
generating a point display image, the point display image being an image in which a plurality of the candidate points are displayed in a spatial image in which the observed object is displayed with a display pattern of each of the plurality of the candidate points, the display pattern being a pattern according to a result of the evaluation, and
outputting the point display image.

19. The non-transitory storage medium according to claim 18, wherein
the point display image is an image in which the candidate point is displayed with a more distinguished display pattern, as the reliability of the candidate point increases.

20. The non-transitory storage medium according to claim 19, wherein
the point display image is an image in which the candidate point having the highest reliability among the plurality of the candidate points which contribute to the signal at the same target point is displayed with a most distinguished display pattern.

21. The non-transitory storage medium according to claim 17, wherein the program causes the computer to further execute
specifying the extracted candidate point and at which a value indicating the reliability is larger than a predetermined threshold value, and
outputting information on the candidate point specified.

22. The non-transitory storage medium according to claim 17, wherein
the geographic information is information in which an index value indicating stability of backward scattering with respect to a radio wave is associated with the earth's surface.

23-24.
